(19) United States
(12) Patent Application Publication
(10) Pub. No.: US 2026/0278656 A1
(43) Pub. Date: Sep. 17, 2026

(54) METHODS AND SYSTEMS FOR PRODUCT SEARCH

(71) Applicant: BloomReach, Inc., Mountain View, CA (US)

(72) Inventors: Yue YU, Chicago, IL (US); Shobhit CHAURASIA, Cupertino, CA (US); Chirayu SAMARTH, San Jose, CA (US); Yixiao LIN, San Mateo, CA (US); Xun WANG, Houston, TX (US)

(21) Appl. No.: 19/077,597

(22) Filed: Mar. 12, 2025

(51) Int. Cl. G06Q 30/0601; G06F 16/2458

(52) U.S. Cl. CPC G06Q 30/0625; G06F 16/2462; G06Q 30/0603

(57) ABSTRACT

Methods and systems for hybrid search are described. In embodiments, a hybrid search method includes: receiving a shopper search query; performing a text search of a product catalog on the search query; performing a vector search of the product catalog on the search query; generating a first recall set of products in the product catalog from performing the text search; generating a second recall set of products in the product catalog from performing the vector search; combining the first recall set and the second recall set into a final recall set; and returning search results including the products listed in the final recall set to a shopper.

### BACKGROUND OF THE INVENTION

### Field of the Invention

Embodiments of the present invention generally relate to e-commerce and, more particularly, to methods and systems for product search.

### Description of the Related Art

Shoppers often search for products online using e-commerce websites, which often have search functions to assist the shopper in finding products. A common type of search for a product is a keyword search, where the shopper enters words or phrases as search terms into a search field of a website or other application. Keyword searching may be very effective for finding specific products (search for “running shoes”), but it can be less effective with complex and more nuanced queries where a product intent is implied, such as “running shoes good for knees.” In the latter search, the intent of the shopper is to not find all running shoes, but to return running shoes that are good for knees. Conventional keyword search engines struggle with product searches where intent is implied since the additional phrases are usually not part of the cataloged product information.

Another type of search is a vector (mathematical representation) search. Vector searching uses machine learning to analyze catalog data and map product relationships as vectors. Vector search presents a wide range of opportunities, but also presents challenges and limitations. One disadvantage of vector searching is the complex implementation process required for vector searching. Such process can require significant computational power and expertise to properly design and implement the algorithms and models needed for vector searching.

Another disadvantage of vector search may include loss of transparency and hidden bias. The inner workings of vector search engines are often opaque since they rely on pre-trained large language models (LLMs) to vectorize the content. This lack of transparency can be a drawback in scenarios where the search results must be explained or justified, such as, for example, in regulatory compliance or auditing processes. In such situations, the inability to explain clearly how the vector search engine arrived at specific results can raise concerns regarding bias or unfairness. Additionally, the lack of transparency can hinder efforts to identify and rectify potential issues or biases in the search algorithm.

Another disadvantage of vector search may include challenges in specialized and niche contexts. Vector search encounters difficulties with rare or niche items, struggles to capture nuanced semantic meanings, and may need more precision in highly specialized fields. This limitation can lead to suboptimal search results in industries where precise terminology is crucial, like legal, healthcare, or scientific research.

Another disadvantage of vector search may include a tradeoff between performance and accuracy. LLM-based content vectorization can provide vectors of varying dimensions. The higher the dimensionality, the more information can be kept in vectors, resulting in more exact search results. The high dimensionality, however, comes at a higher processing cost and slower response times. As a result, vector search engines use approximate closest neighbor (ANN) techniques to accelerate the process while sacrificing some search precision. These algorithms provide outcomes similar, but not identical, to their nearest neighbors. This represents a trade-off between speed and precision, and organizations must decide how much precision they're willing to give up for faster search speeds.

Thus, the inventors provide methods and systems that combine the benefits of text and vector searches that reduce or eliminate the disadvantages associated with text and vector searches.

### SUMMARY OF THE INVENTION

Methods and systems for hybrid search are described. In some embodiments, a hybrid search method includes: receiving a shopper search query; performing a text search of a product catalog on the search query; performing a vector search of the product catalog on the search query; generating a first recall set of products in the product catalog from performing the text search; generating a second recall set of products in the product catalog from performing the vector search; combining the first recall set and the second recall set into a final recall set; and returning search results including the products listed in the final recall set to a shopper.

According to some embodiments, a system for hybrid search includes: one or more processors; a non-transient memory storing instructions, which when executed by the processor cause the processor to perform a method comprising: receiving a shopper search query; performing a text search of a product catalog on the search query; performing a vector search of the product catalog on the search query; generating a first recall set of products in the product catalog from performing the text search; generating a second recall set of products in the product catalog from performing the vector search; combining the first recall set and the second recall set into a final recall set; and returning search results including the products listed in the final recall set to a shopper.

According to some embodiments, a non-transient computer readable medium storing instructions, which when executed by one or more processor, perform a hybrid search method includes receiving a shopper search query; performing a text search of a product catalog on the search query; performing a vector search of the product catalog on the search query; generating a first recall set of products in the product catalog from performing the text search; generating a second recall set of products in the product catalog from performing the vector search; combining the first recall set and the second recall set into a final recall set; and returning search results including the products listed in the final recall set to a shopper.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a representation of a product information in vector space.

FIG. 2 depicts a block diagram of a system in accordance with some embodiments of the present disclosure.

FIG. 3 depicts a hybrid search architecture in accordance with some embodiments of the present disclosure.

FIG. 4 depicts shows a hybrid search method accordance with some embodiments of the present disclosure.

FIG. 5 depicts substeps of a vector search in accordance with some embodiments of the present disclosure.

FIG. 6 depicts substeps of a text search in accordance with some embodiments of the present disclosure.

FIG. 7 depicts a computer system that can be utilized in various embodiments of the invention to implement the computer and/or the display, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

The following detailed description describes techniques (e.g., methods, processes, and systems) for customer engagement. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims.

In embodiments, the methods and systems described herein provide a hybrid search architecture that integrates traditional reverse index search with advanced vector embedding GenAI technologies. This hybrid approach provides a robust solution for the e-commerce product search domain, addressing limitations in standard keyword-based search by incorporating semantic understanding and contextual matching.

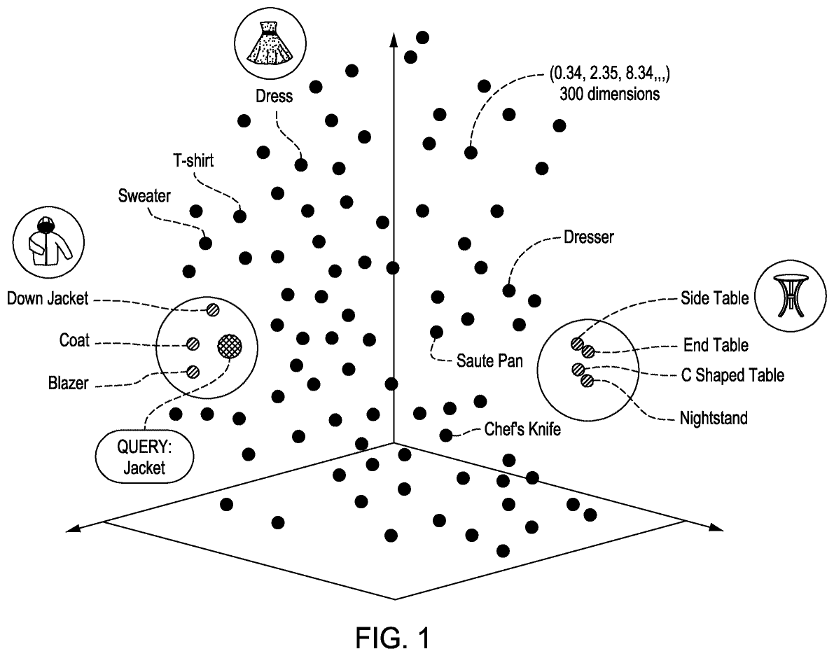

Vector search uses machine learning to interpret catalog data. Vector search understands the semantic relationships between products and translates them into numeric codes called vectors. The vectors are mapped in an n-dimensional space, as shown for example in FIG. 1 with dots. The conceptually related products appear closer in this space, as shown in the spheres. When a shopper searches for a contextual query like “running shoes good for knees,” vector search looks at the vectors to find the closest matches and returns products that fit the shopper's intent.

As used herein, “vector temperature” refers to the breadth or focus of a vector search, represented by the size of spheres in FIG. 1, for example. For example, vector temperature may be analogized to a focus lens that allows adjustment of the precision of search results. In some embodiments, a “standard” vector temperature may be analogized to a “wide-angle lens” that pans out and captures a broad range of related results relative to a “high” vector temperature which may be analogized to a “zoom lens” where the search is more focused, providing highly precise exact matches.

Methods and systems in accordance with embodiments of the present disclosure address the limitations and disadvantages of independently using text (e.g., keyword) and vector searching, particularly for e-commerce catalog product searches, by combining text and vector searching in a manner that goes beyond keywords and leverages vectors (mathematical representations) to decode the core intent behind every search to identify products with shared characteristics.

The methods and system described herein may result in a reduction of null search results because the search engine can understand the context behind each search, even for poorly phrased or misspelled queries. This significantly reduces the chances of null search results, ensuring shoppers always find relevant products, regardless of how they phrase their search. The result is a hybrid search that can provide a wider and more relevant search recall that makes shopping a more intuitive experience for shoppers. Indeed, by combining text and vector searching, e-commerce retailers can showcase exact product matches for specific searches while surfacing related products based on underlying search intent. This provides an opportunity to showcasing a wider set of relevant products, potentially boosting conversion rates and revenue per visit (RPV).

In embodiments described herein, keyword and vector search capabilities are combined, delivering a more relevant and conceptual search experience. In embodiments, the methods and systems described herein provide coverage for multiple query types including at least one of a text or vector query. While keyword search is effective for handling specific queries, vector search goes beyond keywords to understand the nuances behind each query.

The search methods and systems described herein can leverage Large Language Models (LLMs) to display relevant result sets for all query types (head and tail queries). The search methods and systems also intelligently handle natural language queries with comprehensive semantic coverage. In the context of search engine optimization (SEO), “head queries” refer to broad, highly searched keywords with large search volume, while “tail queries” are longer, more specific keyword phrases with lower search volume, essentially representing the “long tail” of search queries, where users are further along in their decision-making process and looking for detailed information.

In embodiments, the methods and systems described herein provide the ability to customize vector temperature controls by adjusting precision of vector search capabilities. This allows ecommerce customers (i.e., retailers) to specify whether to prioritize exact matches for head queries or a broader range of relevant options for tail queries.

The methods and systems described herein result in enhanced shopper experience because the search engine understands search intent, allowing shoppers to find what they need faster and easier, which may lead to a more satisfying shopping journey and increased customer satisfaction.

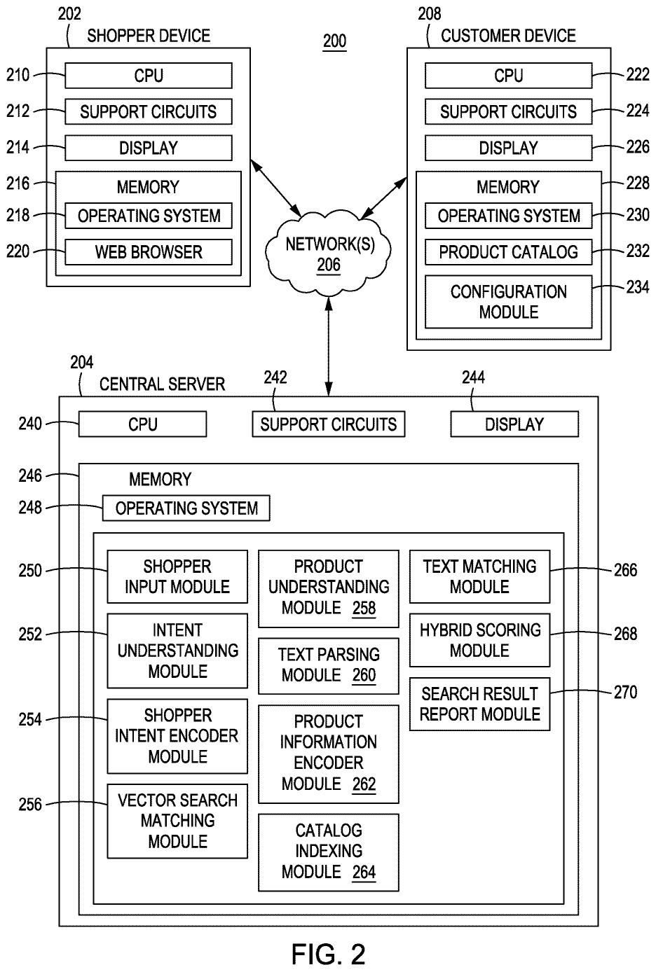

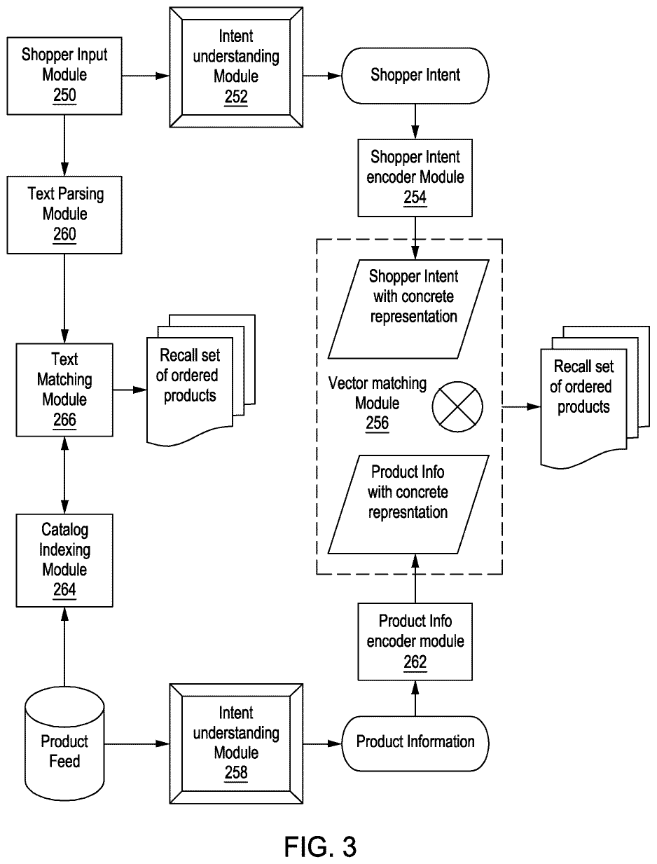

FIG. 2 shows a system 200 in accordance with embodiments of the present disclosure. FIG. 3 shows a hybrid search architecture 300 of the central server in accordance with embodiments of the present disclosure. The system 200 may include a shopper device 202 in network communication with a central server 204 via one or more communication networks 206. The system 200 may also include a customer (e.g., retailer) device 208 connected to the network 206.

The networks 206 comprise one or more communication systems that connect computers by wire, cable, fiber optic and/or wireless link facilitated by various types of well-known network elements, such as hubs, switches, routers, and the like. The networks 206 may include an Internet Protocol (IP) network, a public switched telephone network (PSTN), or other mobile communication networks, and may employ various well-known protocols to communicate information amongst the network resources.

The end-user device (also referred throughout as “shopper device”) 202 comprises a Central Processing Unit (CPU) 210, support circuits 212, display device 214, and memory 216. The CPU 210 may comprise one or more commercially available microprocessors or microcontrollers that facilitate data processing and storage. The various support circuits 212 facilitate the operation of the CPU 210 and include one or more clock circuits, power supplies, cache, input/output circuits, and the like. The memory 216 comprises at least one of Read Only Memory (ROM), Random Access Memory (RAM), disk drive storage, optical storage, removable storage and/or the like. In some embodiments, the memory 216 comprises an operating system 218, and a web browser 220.

The operating system (OS) 218 generally manages various computer resources (e.g., network resources, file processors, and/or the like). The operating system 218 is configured to execute operations on one or more hardware and/or software modules, such as Network Interface Cards (NICs), hard disks, virtualization layers, firewalls and/or the like. Examples of the operating system 218 may include, but are not limited to, various versions of LINUX, MAC OSX, BSD, UNIX, MICROSOFT WINDOWS, IOS, ANDROID and the like.

The web browser 220 is configured to receive search query input and transmit the search query to the central server 204. The web browser 220 is a well know application for accessing and displaying web page content. Such browsers include, but are not limited to, Safari®, Chrome®, Explorer®, Firefox®, etc.

In some embodiments, the customer device 208 includes a Central Processing Unit (CPU) 222, support circuits 224, a display device 226, and memory 228. The CPU 222 may comprise one or more commercially available microprocessors or microcontrollers that facilitate data processing and storage. The various support circuits 224 facilitate the operation of the CPU 222 and include one or more clock circuits, power supplies, cache, input/output circuits, and the like. The memory 228 comprises at least one of Read Only Memory (ROM), Random Access Memory (RAM), disk drive storage, optical storage, removable storage and/or the like. In some embodiments, the memory 228 comprises an operating system 230, a product catalog 232, and a configuration module 234.

The product catalog 232 includes product information about products sold by the customer. The configuration module 234 is configured to allow the customer to customize search-related algorithm settings for language-specific product catalogs. The settings may be used to optimize for unique business needs of the customer. The configuration module 234 may also permit the customer to generate initial vector embeddings and customize the embeddings for the product catalog 232, adjust the vector temperature mode (e.g., standard or high), as well as make adjustments to keyword search related algorithm settings. In some embodiments, the configuration module 234 may include a preview function to allow the customer to see how changes to settings are reflected in search results. In some embodiments, the configuration module 234 may be configured to use real-time data from commerce environments, to update vector embeddings (e.g., daily) to reflect current catalog variations.

In some embodiments, the configuration module 234 may allow the customer to disable hybrid search or override settings by establishing rules on a query-by-query basis. For example, there can be use cases where a customer may want to enable/disable hybrid search functionality for certain queries or use a different level of vector search precision. For instance, as a global or default setting level, the customer may have standard vector temperature set, but the customer may want the specific query “waterproof women's running shoes” to use high vector temperature for a precise recall. In such a case, the configuration module 234 may permit a customer to set a specific override vector temperature on a per query basis which override any global settings.

In some embodiments, the central server 204 includes a Central Processing Unit (CPU) 240, support circuits 242, a display device 244, and memory 246. The CPU 240 may comprise one or more commercially available microprocessors or microcontrollers that facilitate data processing and storage. The various support circuits 242 facilitate the operation of the CPU 240 and include one or more clock circuits, power supplies, cache, input/output circuits, and the like. The memory 246 comprises at least one of Read Only Memory (ROM), Random Access Memory (RAM), disk drive storage, optical storage, removable storage and/or the like. In some embodiments, the memory 246 comprises an operating system 248, a shopper input module 250, an intent understanding module 252, a shopper intent encoder module 254, a vector matching module 256, a product understanding module 258, a text parsing module 260, a product information encoder module 262, a catalog indexing module 264, a text matching module 266, a hybrid scoring module 268, and a search result report module 270.

The hybrid search architecture 300 combines text search (e.g., keyword search) and vector search methodologies to provide a comprehensive search experience. The hybrid search architecture includes the shopper input module 250 that is configured to receive a query that includes various search input from the shopper device. The query received may include one or more types of input, including at least one or more of a text query entered by a shopper, prior shopper purchase history, or shopper conversation with an AI chatbot. The received query may be passed to a text search engine and a vector search engine in parallel or series, as described in greater detail herein.

The shopper input module 250 may also be used to enhance the search query with spelling correction, synonyms, canonicalization, and stopwords removal. In some embodiments, the shopper input module 250 may include a spell correction and synonym handler configured to handle misspellings and synonyms as part of the text search, which may return relevant results without explicit corrections. For example, a received query may include “shrt” which may result in zero or null search results for the text search. However, if there are zero or null search results, the text query may be automatically corrected to search for “shirt,” which may result in the text query returning at least some products in the recall set. In some embodiments, the vector search may not use the corrected spelling for the search and, thus, in the prior example, may perform a vector search for “shrt.” For example, in some embodiments, if the vector search for the original search query for “shrt” returns a non-zero or null vector search result, the query search term may not be autocorrected. In some embodiments, if the vector search query returns zero or null search results, a vector score threshold may be lowered in order to avoid returning null results to the shopper.

In some embodiments, a search query may be adapted or otherwise changed based on whether it contains a brand name. For example, if a search is for a brand name of shoes and the text search retrieves zero or null results, the text search query may be relaxed by searching without the brand name. In some embodiments, if the vector search with the brand name produces zero or null results, the search may be relaxed by searching without the brand name and by lowering a vector score threshold in order to not show null results.

The hybrid search architecture 300 may include the intent understanding module 252 that is configured to convert the shopper query into a shopper intent. In some embodiments, the intent understanding module 252 may use a large language model (LLM) to extract an intent from the shopper query. Also, the hybrid search architecture 300 may include a shopper intent encoder module 254 configured to vectorize the shopper intent. In some embodiments, a GenAI LLM embedding model may be used for query vectors to improve search recall.

The hybrid search architecture 300 may also include the product understanding module 258 which is configured to extract product information from the customer's product catalog 232. In some embodiments, the product understanding module 216 may use a large language model (LLM) to extract product information from the customer's product catalog 232. The hybrid search architecture 300 may also include a product information encoder module 262, which is configured to vectorize the extracted product information. In some embodiments, a GenAI LLM embedding model may be used to generate meaningful product vectors to improve search recall.

The hybrid search architecture 300 may include the vector matching module 256 that is configured to match the vectorized shopper intent with the vectorized product information to return a recall set of products that are relevant to the search query. The vector temperature settings determine how precise the product matches are. Vector search recalls relevant product matches based on the concepts or intent identified from the query. This is based on the vector embeddings generated from the product catalog 232. The vector matching module 256 also scores the recall set of products based on relevance to the search query. In some embodiments, the vector matching module 256 may only include products in the recall set that have at least a threshold relevance score.

The vector matching module 256 may be configured to use temperature settings set by the customer to control the precision of the vector search capabilities to tune the search focus to the shopper's intent dynamically. For example, to find intent with high vector temperature, the vector matching module 256 may narrow the regions around the encoded vectors to retrieve highly relevant and contextual results in instances where shoppers search for very specific products. Customers quickly find what they need, which increases their chances of conversion. On the other hand, to find intent with standard vector temperature, the vector matching module 256 may expand the regions around the encoded vectors based on similar attributes or trends identified via embeddings. For example, if a shopper is searching for “summer dresses,” the vector matching module 256 may also search for dresses with similar features (e.g., floral prints, flowy silhouettes) or complementary items (e.g., sandals, sun hats), which may encourage catalog browsing and exploration and/or impulse purchases.

The hybrid search architecture 300 may include the text parsing module 260 configured to parse text in the search query into keywords used for searching. The hybrid search architecture 300 may include the catalog indexing module 264 configured to index keywords from the customer's product catalog 232. The hybrid search architecture 300 may include the text matching module 266 to match parsed keywords with indexed product information to generate a recall set of products that are scored based on their relevance to the search query. The text search engine retrieves products that match all query parts and synonyms of each query part. The recall set from the text search may be reduced by limiting the recall set to products having at least a threshold relevance score.

The hybrid search architecture 300 may include the hybrid scoring module 268 that is configured to generate a final recall set of products. The final recall set is the union of the recall set from the vector search and the recall set from the text search. Thus, the hybrid search architecture 300 returns the sum of the text search and the vector search recall, which allows the search engine to include all potentially relevant products. The products in the final recall set may be scored according to the following convex combination equation.

$${score}_{convex} ( doc ) = α \times {score}_{lex} ( doc ) + β \times {score}_{sem} ( doc )$$

where α and β are weights and scoreₗₑₓ(doc) is a keyword score for each product recalled via keyword match and scoreₛₑₘ(doc) is a vector score for each product recalled via vector search. The keyword score and vector scores may be normalized and scaled scores, e.g., 0 to 1. Thus, if a product is in both the recall set from the vector search and the text search, the product is scored more highly in the final recall set since it appears in both recall sets.

In some embodiments, text search recall may receive a higher ranking preference over vector search recall. In some embodiments, the primary signals for search ranking include performance signals like query-specific revenue, conversion, ATC, and views, as well as sitewide revenue, conversion, ATC, and views. In some embodiments, the global performance and popularity of products may be factored in when ranking them. By using a relevance-aware global performance signal, products that are relevant and have high sitewide performance may receive an additional boost in score over those with low sitewide performance.

In some embodiments the hybrid search architecture 300 may include the search result report module 270 that may return at least some of the products in the final recall set to the shopper device 202, such as via the web browser 220. In some embodiments, the products returned may be limited based on a threshold score (all products with at least a certain score) or by an amount of products (e.g., the top 20 highest scored products)

The hybrid search architecture 300 is scalable and flexible. In some embodiments, the hybrid search architecture 300 supports integration with Solr infrastructure and Google's Vertex AI, maintaining data consistency and synchronization.

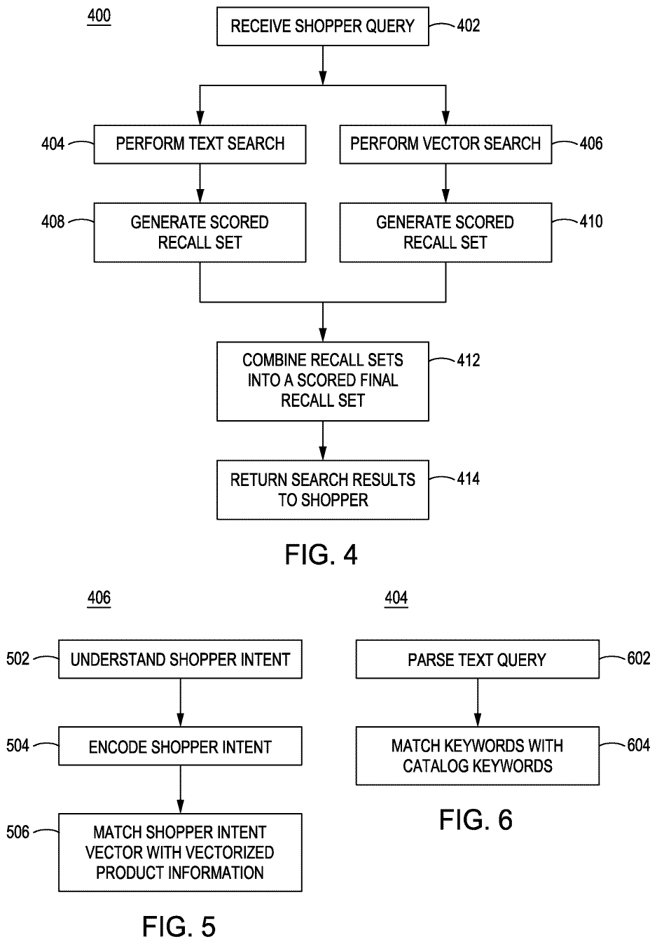

FIG. 4 shows a hybrid search method 400 in accordance with some embodiments of the present disclosure. At block 402, the method 400 includes receiving a shopper search query, e.g., from the shopper device 202. As noted above, the search query may include various input, such as text query, as well as other information such as purchase history, or information about the shopper (e.g., age, shopping preferences, demographics, etc.) which may inform the search results.

At block 404 the method may include performing a text or keyword search and at block 406 the method may include performing a vector search. The text search and vector search may be performed in parallel (as shown in FIG. 4) or in series. At blocks 408 and 410 scored recall sets are generated from the text search and the vector search. At block 412, the method 400 includes combining the two recall sets in a scored final recall set as described above using the convex combination equation. At block 414, the method 400 may include returning search results to the shopper device 202.

FIG. 5 shows substeps of performing the vector search at block 406 in FIG. 4. At block 502, the method 400 includes understanding shopper intent, such as by using the intent understanding module 252. At block 504, the method 400 includes encoding shopper intent, such as by using the shopper intent encoder module 254. At block 506, the method 400 includes matching shopper intent vectors with vectorized product information, such as by using the vector matching module 256.

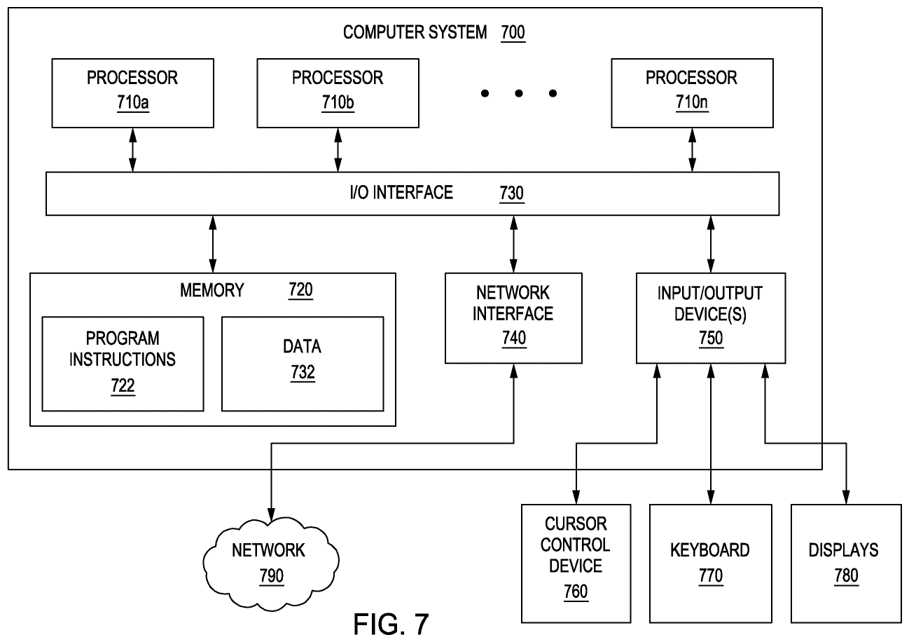

FIG. 6 shows substeps of performing the text search at block 404 in FIG. 4. At block 602, the method 400 includes parsing a text query, such as by using the text parsing module 260. At block 604, the method 400 includes matching parsed keywords from the query with catalog keywords, such as by using the text matching module 266.

FIG. 7 depicts a computer system 700 that can be utilized in various embodiments of the invention to implement the computer and/or the display, according to one or more embodiments.

Various embodiments of method and system for a hybrid search, as described herein, may be executed on one or more computer systems, which may interact with various other devices. One such computer system is computer system 700 illustrated by FIG. 7, which may in various embodiments implement any of the elements or functionality illustrated in FIGS. 1-6. In various embodiments, computer system 700 may be configured to implement methods described above. The computer system 700 may be used to implement any other system, device, element, functionality or method of the above-described embodiments. In the illustrated embodiments, computer system 700 may be configured to implement the method 400 as processor-executable executable program instructions 722 (e.g., program instructions executable by processor(s) 710) in various embodiments.

In the illustrated embodiment, computer system 700 includes one or more processors 710a-710n coupled to a system memory 720 via an input/output (I/O) interface 730. Computer system 700 further includes a network interface 740 coupled to I/O interface 730, and one or more input/output devices 750, such as cursor control device 760, keyboard 770, and display(s) 780. In various embodiments, any of the components may be utilized by the system to receive user input described above. In various embodiments, a user interface may be generated and displayed on display 780. In some cases, it is contemplated that embodiments may be implemented using a single instance of computer system 700, while in other embodiments multiple such systems, or multiple nodes making up computer system 700, may be configured to host different portions or instances of various embodiments. For example, in one embodiment some elements may be implemented via one or more nodes of computer system 700 that are distinct from those nodes implementing other elements. In another example, multiple nodes may implement computer system 700 in a distributed manner.

In different embodiments, computer system 700 may be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments processors 710 may be general-purpose or embedded processors implementing any of a variety of instruction set architectures (ISAs). In multiprocessor systems, each of processors 710 may commonly, but not necessarily, implement the same ISA.

System memory 720 may be configured to store program instructions 722 and/or data 732 accessible by processor 710. In various embodiments, system memory 720 may be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 720. In other embodiments, program instructions and/or data may be received, sent or stored upon different types of computer-accessible media or on similar media separate from system memory 720 or computer system 700.

In one embodiment, I/O interface 730 may be configured to coordinate I/O traffic between processor 710, system memory 720, and any peripheral devices in the device, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. Also, in some embodiments some or all of the functionality of I/O interface 730, such as an interface to system memory 720, may be incorporated directly into processor 710.

Network interface 740 may be configured to allow data to be exchanged between computer system 700 and other devices attached to a network (e.g., network 790), such as one or more external systems or between nodes of computer system 700. In various embodiments, network 790 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 740 may support communication via wired or wireless general data networks, such as any suitable type of Ethernet network, for example; via digital fiber communications networks; via storage area networks such as Fiber Channel SANs, or via any other suitable type of network and/or protocol.

Input/output devices 750 may, in some embodiments, include one or more display terminals, keyboards, keypads, touchpads, scanning devices, voice or optical recognition devices, or any other devices suitable for entering or accessing data by one or more computer systems 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

In some embodiments, the illustrated computer system may implement any of the operations and methods described above, such as the methods illustrated by the flowchart of FIGS. 4-6. In other embodiments, different elements and data may be included.

Those skilled in the art will appreciate that computer system 700 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media, which may be read and executed by one or more processors. A machine-readable medium may include any mechanism for storing or transmitting information in a form readable by a machine (e.g., a computing device or a “virtual machine” running on one or more computing devices). For example, a machine-readable medium may include any suitable form of volatile or non-volatile memory.

Modules, data structures, and the like defined herein are defined as such for ease of discussion and are not intended to imply that any specific implementation details are required. For example, any of the described modules and/or data structures may be combined or divided into sub-modules, sub-processes or other units of computer code or data as may be required by a particular design or implementation.

In the drawings, specific arrangements or orderings of schematic elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application-programming interface (API), and/or other software development tools or frameworks. Similarly, schematic elements used to represent data or information may be implemented using any suitable electronic arrangement or data structure. Further, some connections, relationships or associations between elements may be simplified or not shown in the drawings so as not to obscure the disclosure.

While the foregoing is directed to embodiments of the present disclosure, other and further embodiments of the disclosure may be devised without departing from the basic scope thereof.

What is claimed is:

1. A hybrid search method comprising:
receiving a shopper search query;
performing a text search of a product catalog on the search query;
performing a vector search of the product catalog on the search query;
generating a first recall set of products in the product catalog from performing the text search;
generating a second recall set of products in the product catalog from performing the vector search;
combining the first recall set and the second recall set into a final recall set; and
returning search results including the products listed in the final recall set to a shopper.

2. The hybrid search method of claim 1, wherein:
performing the vector search includes:
understanding shopper intent from the search query;
vectorizing the shopper intent; and
matching shopper intent vectors with vectorized product information from the product catalog.

3. The hybrid search method of claim 1, wherein:
performing the text search on the search query includes:
parsing text in the search query into keywords; and
matching keywords with keywords from the product catalog.

4. The hybrid search method of claim 1, wherein combining the first recall set and the second recall set includes scoring the products in the first recall set and the second recall set according to the following convex combination equation.
$${score}_{convex} ( doc ) = α \times {score}_{lex} ( doc ) + β \times {score}_{sem} ( doc )$$
where α and β are weights and scoreₗₑₓ(doc) is a keyword score for each product recalled via keyword match and scoreₛₑₘ(doc) is a vector score for each product recalled via vector search.

5. The hybrid search method of claim 1, further comprising vectorizing product information from the product catalog.

6. The hybrid search method of claim 1, further comprising keyword indexing product information from the product catalog.

7. The hybrid search method of claim 1, wherein the products in the first recall set and the second recall set are scored according to relevance to the search query.

8. A system for hybrid search, the system comprising:
one or more processor;
a non-transient memory storing instructions, which when executed by the processor cause the processor to perform a method comprising:
receiving a shopper search query;
performing a text search of a product catalog on the search query;
performing a vector search of the product catalog on the search query;
generating a first recall set of products in the product catalog from performing the text search;
generating a second recall set of products in the product catalog from performing the vector search;
combining the first recall set and the second recall set into a final recall set; and
returning search results including the products listed in the final recall set to a shopper.

9. The system of claim 8, wherein:
performing the vector search includes:
understanding shopper intent from the search query;
vectorizing the shopper intent; and
matching shopper intent vectors with vectorized product information from the product catalog.

10. The system of claim 8, wherein:
performing the text search on the search query includes:
parsing text in the search query into keywords; and
matching keywords with keywords from the product catalog.

11. The system of claim 8, wherein combining the first recall set and the second recall set includes scoring the products in the first recall set and the second recall set according to the following convex combination equation.
$${score}_{convex} ( doc ) = α \times {score}_{lex} ( doc ) + β \times {score}_{sem} ( doc )$$
where α and β are weights and scoreₗₑₓ(doc) is a keyword score for each product recalled via keyword match and scoreₛₑₘ(doc) is a vector score for each product recalled via vector search.

12. The system of claim 8, further comprising vectorizing product information from the product catalog.

13. The system of claim 8, further comprising keyword indexing product information from the product catalog.

14. The system of claim 8, wherein the products in the first recall set and the second recall set are scored according to relevance to the search query.

15. A non-transient computer readable medium storing instructions, which when executed by one or more processor, perform a hybrid search method comprising:
receiving a shopper search query;
performing a text search of a product catalog on the search query;
performing a vector search of the product catalog on the search query;
generating a first recall set of products in the product catalog from performing the text search;
generating a second recall set of products in the product catalog from performing the vector search;
combining the first recall set and the second recall set into a final recall set; and
returning search results including the products listed in the final recall set to a shopper.

16. The non-transient computer readable medium of claim 15, wherein:
performing the vector search includes:
understanding shopper intent from the search query;
vectorizing the shopper intent; and
matching shopper intent vectors with vectorized product information from the product catalog.

17. The non-transient computer readable medium of claim 15, wherein:
performing the text search on the search query includes:
parsing text in the search query into keywords; and
matching keywords with keywords from the product catalog.

18. The non-transient computer readable medium of claim 15, wherein combining the first recall set and the second recall set includes scoring the products in the first recall set and the second recall set according to the following convex combination equation.
$${score}_{convex} ( doc ) = α \times {score}_{lex} ( doc ) + β \times {score}_{sem} ( doc )$$
where α and β are weights and scoreₗₑₓ(doc) is a keyword score for each product recalled via keyword match and scoreₛₑₘ(doc) is a vector score for each product recalled via vector search.

19. The non-transient computer readable medium of claim 15, further comprising vectorizing product information from the product catalog; and keyword indexing product information from the product catalog.

20. The non-transient computer readable medium of claim 15, wherein the products in the first recall set and the second recall set are scored according to relevance to the search query.
